(19) United States
(12) Patent Application Publication
(10) Pub. No.: US 2002/0148163 A1
(43) Pub. Date: Oct. 17, 2002

(54) Sliding window for use in pick-up truck rear window assembly

(75) Inventors: Gary W. Warner, Rochester Hills, MI (US); Andrew T. Billiu, Farmington Hills, MI (US); Mark A. Schreiner, Tiffin, OH (US); Vincent M. Kirchner, Tiffin, OH (US)

Correspondence Address: NIXON & VANDERHYE P.C., 8th Floor, 1100 North Glebe Road, Arlington, VA, 22201, US

(73) Assignee: Gurdian Industries Corporation

(21) Appl. No.: 10/106,894

(22) Filed: Mar. 27, 2002

Related U.S. Application Data
(60) Provisional application No. 60/278,752, filed on Mar. 27, 2001.

(51) Int. Cl. E05D 15/10

(52) U.S. Cl. 49/209

(57) ABSTRACT

A rear window assembly for a pick-up truck. A slidable window panel is provided between first and second fixed window panels. In order to open the slidable window panel, at least a portion thereof is popped outwardly and thereafter the panel is slid along at least first and second tracks to an open position. In certain embodiments, opaque layer(s) may be provided on an exterior surface of the slidable panel in order to hide from view support arm(s) or the like utilized for supporting the slidable panel as it is slid to its open/closed position. Moreover, in certain embodiments tracks are located on the inboard side of the slidable panel in locations so as to be at least partially hidden from view. A power opening/closing system for the window is provided in certain embodiments. A spring-biased window closing system is provided in certain embodiments.

This application claims priority from U.S. Provisional Pat. App. No. 60/278,752, filed Mar. 27, 2001, the disclosure of which is hereby incorporated herein by reference.

This invention relates to a sliding window for use in a pick-up truck rear window assembly. More particularly, certain embodiments of this invention relate to a rear window assembly for a pick-up truck which includes at least one slidable panel that is at least partially transparent.

### BACKGROUND OF THE INVENTION

Sliding windows used in conjunction with rear window assemblies of pick-up trucks are known in the art. For example, see U.S. Pat. Nos. 5,996,284; 5,822,922; 5,775,029; 4,920,698; and 4,124,054, the disclosures of which are all hereby incorporated herein by reference. Unfortunately, conventional slidable rear window assemblies for pick-up trucks are often undesirably complex and include a vast number of components.

It will be apparent to those skilled in the art that there exists a need in the art for a simplified rear window assembly for a pick-up truck which includes at least one slidable panel.

### SUMMARY OF THE INVENTION

An object of this invention is to provide a slidable window for use in a rear window assembly for a pick-up truck.

In certain embodiments, a pop-out rear sliding window is provided between first and second fixed windows. Pop-out action takes at least a leading end of the center glass window or module rearwardly toward the bed of the pick-up truck, and guides it into a sliding track(s). The trailing end may stay approximately in place. The center window may then be slid along three or more tracks (e.g., two tracks for the leading edge of the center window and at least one track for guiding the trailing edge) into an open position. As the window is opened, the trailing edge is tracked so that it moves more outwardly as the window is slid open, until it is approximately as far out as the leading edge. As the window is closed, the leading edge (i.e., the trailing edge when being opened) follows its track(s) moving progressively inboard as it approaches a sealing closed position at which point a latch(es) is shut pulling the trailing edge (i.e., the leading edge when being opened) into sealing engagement much like a pop-out window.

Generally speaking, in certain example embodiments of this invention, one or more objects and/or needs are fulfilled by providing a rear window assembly for a pick-up truck, comprising: first and second fixed window panels; a slidable window panel located between and approximately flush with the first and second fixed window panels when in a closed position; at least upper and lower elongated tracks for enabling the slidable window panel to slide from the closed position to an open position, and wherein each of said upper and low tracks are on an inboard side of said slidable window panel so that the slidable panel is located between a bed of the pick-up truck and said tracks.

Other example embodiments of this invention fulfill one or more of the above listed objects and/or needs by providing a rear window assembly for a pick-up truck, comprising: first and second fixed window panels; a slidable window panel located between and approximately flush with the first and second fixed window panels when in a closed position; at least upper and lower elongated tracks for enabling the slidable window panel to slide from the closed position to an open position, and vice versa; a pivot member attached to the slidable window panel via at least one support, the pivot member sliding in one of the elongated tracks during opening and closing of the slidable window; and a spring applying a biasing force to the pivot member so that the slidable window is biased toward a position where it is approximately flush with the first and second fixed window panels.

Other example embodiments of this invention fulfill one or more of the above-listed objects and/or needs by providing a rear window assembly for a pick-up truck, comprising: first and second fixed window panels; a slidable window panel located between and approximately flush with the first and second fixed window panels when in a closed position; and means for biasing the slidable window panel toward the closed position where it is approximately flush with the first and second fixed window panels, the means for biasing comprising a spring for biasing a pivoting member that is operatively associated with the slidable window panel.

Other example embodiments of this invention fulfill one or more of the above-listed objects and/or needs by providing a rear window assembly for a pick-up truck, comprising: first and second fixed window panels; a slidable window panel located between and approximately flush with the first and second fixed window panels when in a closed position; and a power system for laterally moving the slidable window panel during opening and closing of the slidable window, the power system comprising an elongated screw on which at least one threaded collar is threadedly mounted, said at least one collar being attached to the slidable window panel via at least a pivoting link member pivotally associated with the collar and a bracket having a channel defined therein for slidingly receiving a sliding member attached to the link so that during opening of the slidable window panel rotation of the screw causes the collar, the link, the sliding member and the slidable window panel to move laterally.

### BRIEF DESCRIPTION OF THE DRAWINGS

FIG. 1 is a partial perspective view of a pick-up truck according to an embodiment of this invention.

FIG. 2 is a top cross-sectional view of the three window panels of the rear window assembly of FIG. 1, with the center slidable panel illustrated in a closed position (dotted lines show the center panel in a popped out position).

FIG. 3 is a top cross-sectional view of the three window panels of FIGS. 1-2, with the slidable window panel illustrated in an exemplary open position.

FIG. 4a is a top cross-sectional view of an edge of the slidable window panel of FIGS. 1-3, located adjacent a supporting member, wherein the panel is in a closed position.

FIG. 4b is a top cross-sectional view of the panel edge of FIG. 4a, as the panel is being pushed or popped out during an opening procedure.

FIG. 5a is a top cross-sectional view of an edge of the slidable window panel of FIGS. 1-3, located adjacent a supporting member, in a closed position according to another embodiment of this invention.

FIG. 5b is a top cross-sectional view of the window edge of FIG. 5a as it is being popped out during an opening procedure.

FIG. 6 is a side cross-sectional view of the pick-up truck rear window assembly of FIGS. 1-4, when the slidable panel is in an exemplary open position.

FIGS. 7(a)-7(b) are top partial cross sectional views illustrating a method and corresponding structure for progressively opening a pick-up truck rear window according to another embodiment of this invention.

FIG. 8(a) is a perspective view of a system for power opening/closing a pick-up truck rear window according to an embodiment of this invention.

FIG. 8(b) is a close-up perspective view of a portion of FIG. 8(a).

### DETAILED DESCRIPTION OF CERTAIN EMBODIMENTS OF THIS INVENTION

Referring now more particularly to the accompanying drawings in which like reference numerals indicate like parts throughout the several views.

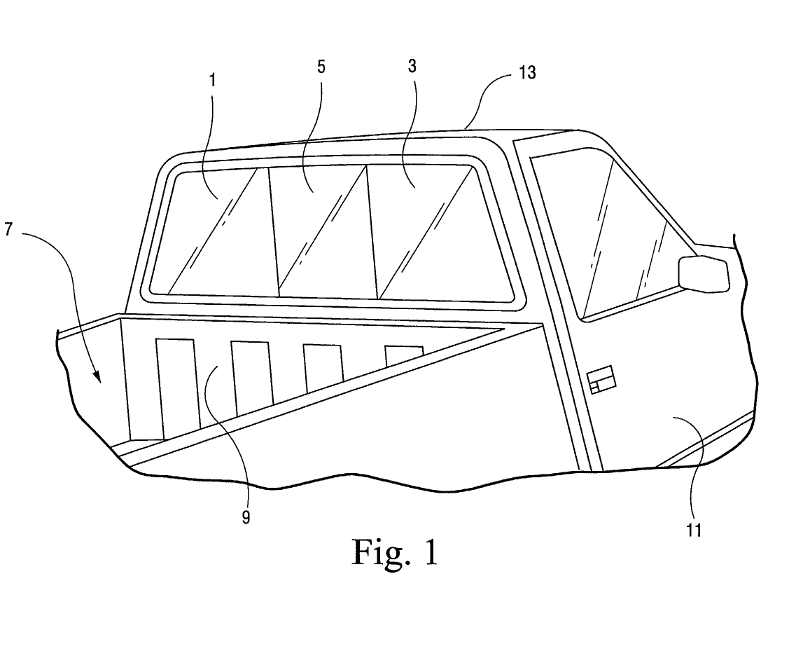

FIG. 1 illustrates a pick-up truck according to an embodiment of this invention. The pick-up truck includes a rear window assembly including fixed window 1, another fixed window 3, and slidable center window 5 which is located between the two fixed windows 1, 3 when in a closed position. The pick-up truck further includes front door 11, cab roof 13, and truck bed 7 defined at least in part by front bed wall 9. As can be seen, the rear window assembly of the pick-up truck is provided forward of vertically extending front bed wall 9. Window panels 1, 3, and 5 are preferably of glass, but alternatively may be of plastic in certain embodiments of this invention.

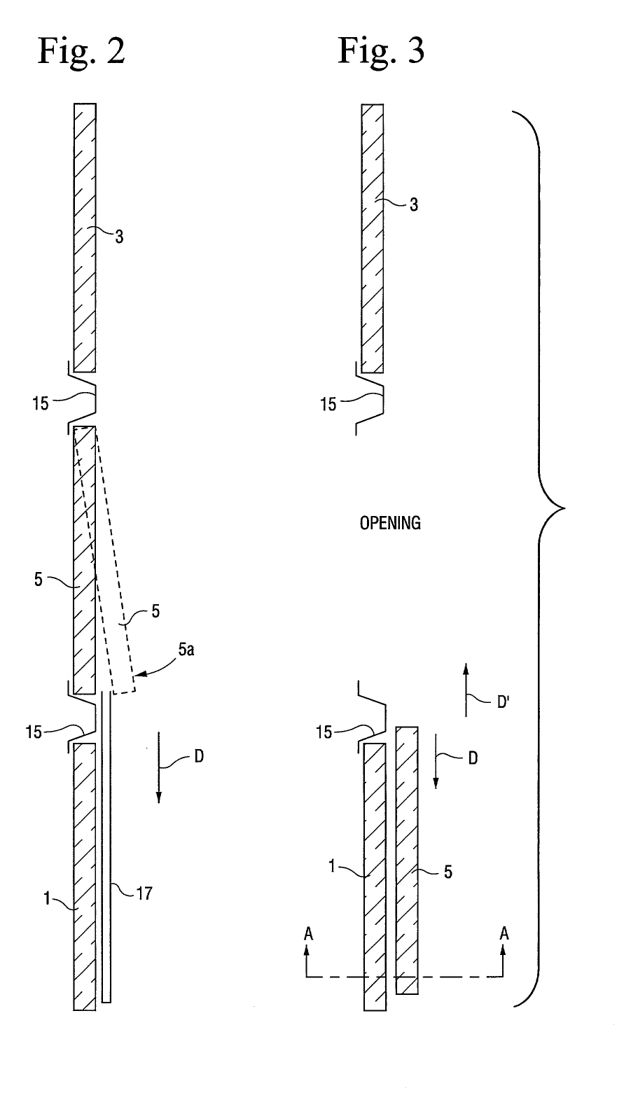

FIG. 2 is a top cross-sectional view of a portion of the rear window assembly of FIG. 1, when the slidable glass panel 5 is in a closed position. As can be seen in FIG. 2, when panel 5 is in a closed position it is approximately flush with the two panels 1 and 3 on either side thereof. According to certain embodiments of this invention, vertically aligned support members 15 (e.g., of sheet metal and/or plastic) may be provided between slidable window 5 and the windows 1, 3 on either side thereof for sealing purposes. Also shown in FIG. 2 is an exemplary bottom track 17 which supports a leading edge of panel 5 in a sliding manner as it moves from its popped out closed position to an open position. panel 5 in its closed position flush or approximately flush with panels 1 and 3. When it is desired to open panel 5, at least one end 5a thereof is pushed or popped outwardly toward the bed 7 of the pick-up truck as shown by the dotted line illustration of panel 5 in FIG. 2. During opening, in certain preferred embodiments of this invention, one side of panel 5 pops outwardly while the other side remains approximately in place as shown in FIG. 2. This dotted line position of the panel 5 may be referred to herein as a popped out closed position of panel 5.

This popping outward of panel 5 enables a roller(s) associated with panel 5 to move into bottom slider track 17 and another roller to move into a top slider track approximately parallel to the bottom track 17. After at least one side of window 5 has been popped out as illustrated in dotted lines in FIG. 2, panel 5 is slid sideways in direction D along at least track 17 and an upper track (not shown in FIG. 2) to its open position which is shown in FIG. 3. As panel 5 is slid into its open position, the trailing edge of the panel gradually moves outwardly toward the bed of the truck until it too is spaced outwardly from panels 1 and 3 and panel 5 is approximately parallel to panel 1. In order to slide panel 5 from its FIG. 3 open position back to its closed position, the panel is slid in a reverse direction D prime (i.e., D′) with its leading edge gradually moving inwardly away from the truck bed until the panel reaches the FIG. 2 dotted line position. From there, a handle attached to the panel 5 may be utilized to pull end 5a of panel 5 inwardly until it reaches its closed and sealed position shown in solid lines in FIG. 2.

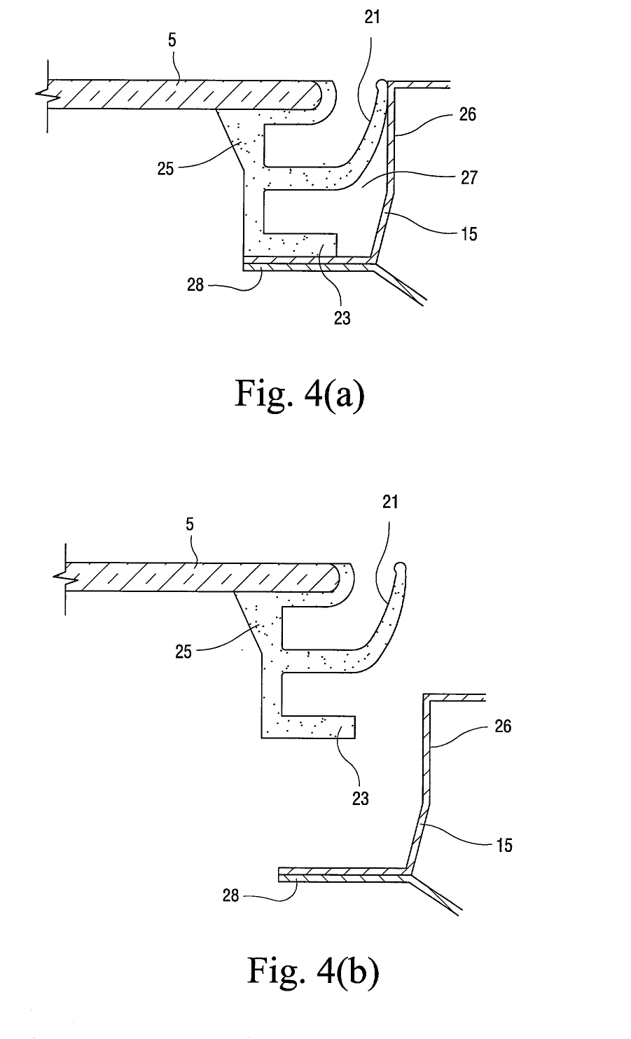

FIGS. 4a and 4b illustrate an edge of slidable panel 5 adjacent a support 15 according to an embodiment of this invention. As shown, a polymer edge sealing member is attached adjacent the edge of panel 5. The polymer edge sealing member includes flexible weather sealing lip 21 and supporting lip 23 which extend from base portion 25. This polymer edge sealing member may be formed by extrusion, reaction injection molding, or the like; and may be made of polyurethane or any other suitable material. Flexible lip 21 is biased against vertical wall 26 of support 15 in order to prevent water and the like from entering cavity 27 and/or the vehicle interior. Supporting lip 23 of the polymer member contacts and rests against wall 28 of support 15 in order to prevent panel 5 from moving further in the direction of the cab interior and so as to create another seal between the window and support 15.

While FIG. 4a shows panel 5 in a closed position (e.g., see also FIG. 2), FIG. 4b illustrates the panel along with its edge sealing member as it is being popped out or moved outwardly toward the truck bed during the course of an opening procedure. Once panel 5 is moved outwardly away from support 15, it enters one or more sliding tracks so that it may be slid into the open position shown in FIG. 3.

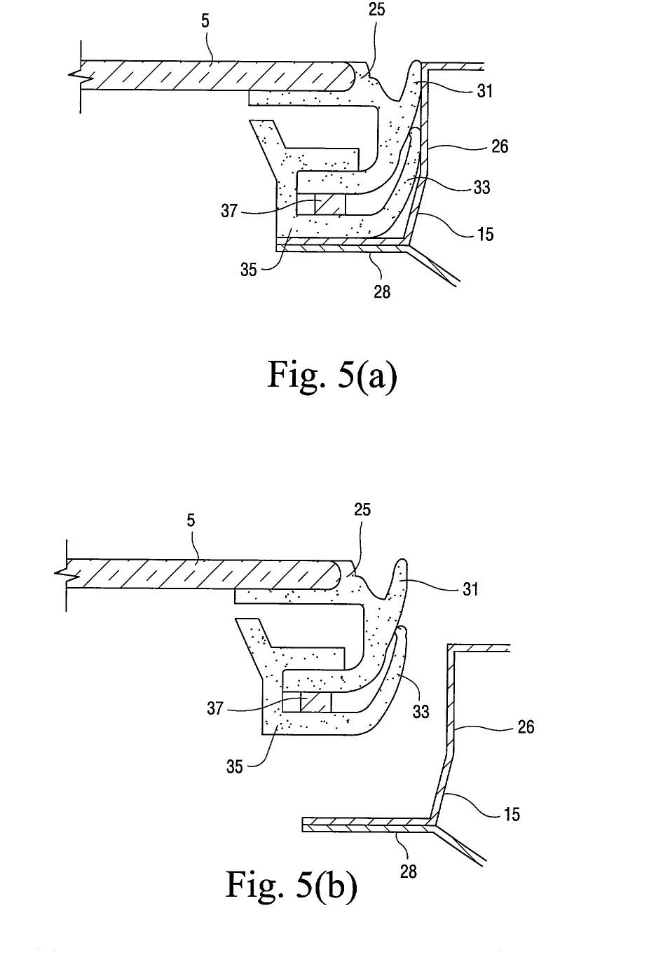

FIGS. 5a-5b illustrate an edge seal of panel 5 according to another embodiment of this invention. FIGS. 5a-5b are similar to FIGS. 4a-4b, except that the polymer edge sealing member is shaped differently in the FIG. 5 embodiment. In the FIG. 5 embodiment, the polymer edge seal includes flexible weather sealing lips 31 and 33, polymer support 35, and adhesive 37 for joining the second polymer profile including 33, 35 to the first polymer profile including lip 31 and base 25.

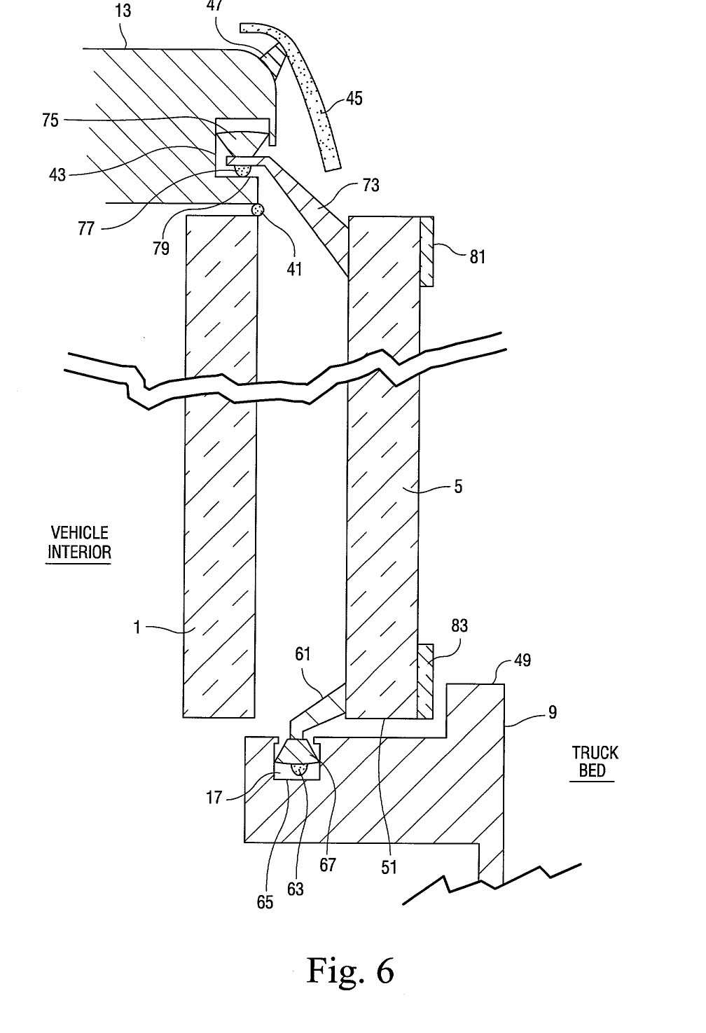

FIG. 6 is a side cross-sectional view of the window assembly of FIGS. 1-4, when the panel 5 is in an open position. In particular, the cross-sectional view of FIG. 6 is taken along section line A-A in FIG. 3. As shown in FIG. 6, when in the open position at least partially transparent panel 5 (at least 70% transparent to visible light in certain embodiments) is spaced outwardly from and approximately parallel to fixed glass panel 1. Fixed panel 1 is mounted in the truck cab, and one or more seals 41 may be provided in order to securely mount panel 1 and prevent water from leaking into the cab/vehicle interior. Meanwhile, to reach its open position shown in FIG. 6, panel 5 has been slid via upper/top track 43 and lower track 17 from its FIG. 2 closed position to its FIG. 3 open position. Upper track 43 and lower track 17 are preferably elongated in shape, approximately parallel to one another, and are linear in certain example embodiments of this invention.

The track(s) for the trailing edge of panel 5 are not shown. However, it is pointed out that a three track system may be used in certain embodiments of this invention. Two tracks 17, 43 support the leading edge of the window when it is being slid open, these tracks being located/positioned behind the panel 5 (i.e., on the side of the panel opposite the truck bed) so that in certain instances they may not be visible unless the window is in an open position. A third track (not shown) guides and supports the trailing edge of panel 5 when it is being opened (i.e., same as the leading edge when being closed). Optionally, this third track can be located near the vertical center of panel 5 so that variation is split evenly between the top and the bottom. In this case, the third track can be located either above or below the fixed glass panel portion of the module (below may allow for more space and be visually more acceptable).

Still referring to FIG. 6, it can be seen that upper elongated track 43 may be hidden from view by spoiler 45 which is attached proximate a rear edge of roof 13 of the pick-up truck cab via spoiler support 47. Upper track 43 may be formed in the body of the cab adjacent the roof 13, or via any other suitable material/structure. Lower elongated track 17 is preferably formed at an elevation below the top 49 of front truck bed wall 9. This enables the bottom edge 51 of glass panel 5 as well as track 17 to be hidden from view from one standing at the rear of the pick-up truck at least when the panel is in an open and/or closed position. As can be seen, both tracks 17 and 43 are located on the inboard side (i.e., vehicle interior side) of panel 5 when the panel is in an open position.

Lower support arm 61 is attached to and extends from a lower portion of panel 5. Operatively associated and/or attached to a distal end of lower support arm 61 are roller 63 which contacts the bottom wall 65 of track 17 and roller 67 which contacts the sidewalls of track 17. Roller 67 is rotatable about a vertical axis, while roller 63 is rotatable about at least a horizontal axis. Rollers 63 and 67 function to keep the distal end of support arm 61 in and/or proximate track 17 during the sliding process of panel 5 during opening/closing of the window 5. In a similar manner, upper support arm 73 (or polymer, metal or the like) extends from a top portion of slidable panel 5. Operatively associated with and/or connected to the distal end of arm 73 are rollers 75 and 77. Roller 77 contacts and rolls on the lower wall 79 of track 43 while roller 75 contacts and rolls on the opposing sidewalls of track 43. Roller 75 rotates about at least a vertical axis, while roller 77 rotates about at least a horizontal axis. Rollers 75 and 77 function to maintain the distal end of arm 73 in or proximate upper track 43 as panel 5 is slid open/closed.

According to certain example embodiments of this invention, opaque layers 81 and/or 83 are provided on the exterior surface of glass panel 5 in order to hide or shield from view arms 73 and 61, tracks, and/or rollers. Layers 81 and/or 83 may be of or include black enamel or paint, dark paint, opaque silk screened frit, or any other suitable opaque material.

As will be appreciated by those skilled in the art, the locations of tracks 17 and 43, when combined with opaque layers 81 and/or 83, and optionally spoiler 45 provides for an aesthetically pleasing rear pick-up truck window (e.g., certain parts thereof are efficiently hidden from view). In particular, tracks 17 and/or 43 are difficult to see from the rear of the truck in view of wall 9, spoiler 45, and/or opaque layer(s) 81, 83. Likewise, arms 61 and/or 73 are difficult to see from the rear of a truck in view of at least opaque layer(s) 81, 83 and/or wall 9. This overall combination provides for an aesthetically pleasing appearance for the rear window assembly of the pick-up truck according to certain embodiments of this invention.

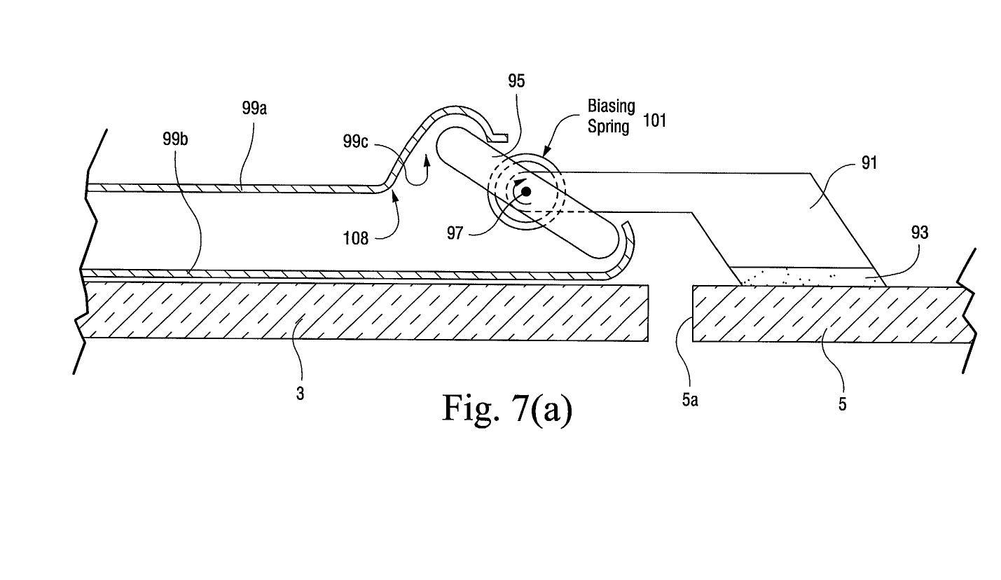

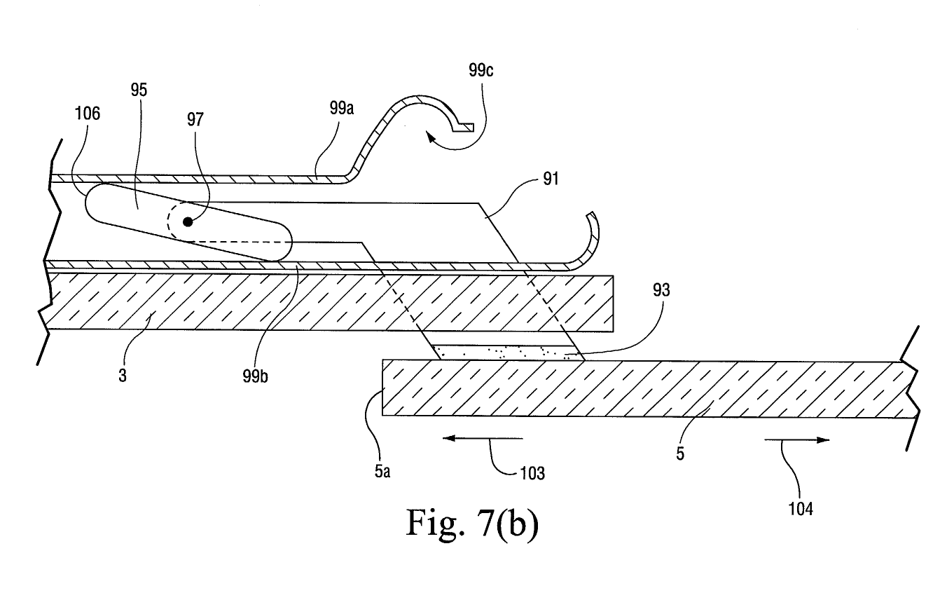

FIGS. 7(a)-7(b) are top partial cross sectional views illustrating a method and corresponding structure for progressively opening a pick-up truck rear window according to another embodiment of this invention. The assembly of this embodiment includes movable glass window panel 5, fixed window panel 3, support bracket 91 attached to movable panel 5 via adhesive 93, pivot member 95 pivotally attached to an end of support bracket 91 at pivot point/axis 97, rail or bracket assembly 99 (including first and second track members 99a and 99b which are at least in part parallel to one another) for allowing pivot member 95 to slide therein for guiding the panel 5 during the opening/closing process, and biasing spring 101 for biasing the pivot member 95 in the clockwise direction as shown in FIG. 7 (the biasing spring 101 is not shown in FIG. 7(b) for purposes of simplicity).

FIG. 7(a) illustrates the central window panel 5 in the closed position where it is flush or approximately flush with adjacent panels 1 and 3. Meanwhile, FIG. 7(b) illustrates panel 5 in the process of being opened/closed in this embodiment. FIG. 7 illustrates only one bracket 91, only one pivot member 95, only one sliding track 99, etc.; however, those skilled in the art will recognize that there are two such assemblies provided, namely a first such assembly at the top and a second such assembly (not shown) at the bottom of the window panels. Thus, a first bracket 91 is attached to a top of panel 5 so that its pivot member 95 can slide through the top track 99 during the opening/closing process; and a second bracket 91 (second assembly not shown) is attached to the bottom of panel 5 so that its pivot member (not shown) can slide through the bottom track 99 (not shown) during the same opening/closing process. In certain embodiments of this invention, both (a) the panel 5 moves outward toward the truck bed in order to open the same, and (b) the tracks 99 are also on the exterior of the vehicle (e.g., built into or covered by a spoiler or the like so as to be hidden from view); in such cases the panels 1, 3, 5 are laterally offset from the tracks 99 so as to be rearward thereof in both opened and closed window positions. In other embodiments, the widow panel 5 may move outward toward the truck bed in order to open the same, while the tracks 99 are on the vehicle interior. In certain embodiments, both tracks 99 may be on the exterior of the vehicle (e.g., the top track may be built into or hidden by a spoiler or the like) even though the tracks are on the inboard side of the window panel as shown in FIG. 7, since the window panels may be offset from the track positions.

The opening/closing process will now be described with respect to FIGS. 7(a) and 7(b). FIG. 7(a) illustrates window panel 5 in a closed position, flush with the other two panels 1, 3. Spring 101 biases pivot member 95 in the clockwise direction as shown in FIG. 7 so that when panel 5 is closed the spring 101 biases pivot member 95 so that one end of the pivot member is positioned in a recess 99c defined in an end of track member 99a. Thus, it can be seen that spring 101 biases the panel 5 into the closed position shown in FIG. 7(a). When a user desires to open panel 5, he/she moves (e.g. pops out the panel 5 toward the vehicle exterior and thus toward the truck bed as shown in FIG. 2) the panel 5 transversely so that at least one side 5a of the panel moves in a direction away from track 99 so that panel 5 is no longer flush with fixed panel 3. This initial movement is similar to that shown in FIG. 2. When panel 5 is moved in such a manner (e.g., popped out), the panel 5 can then be slid sideways in direction 103 in order to fully open the window as shown in FIG. 7(b). When panel 5 is being slid sideways in direction 103, pivot member 95 is sliding down the length of track 99 between members 99a and 99b. During such sliding of panel 5 and pivot member 95, spring 101 is still biasing pivot member 95 so that the pivot member 95 has one end thereof biased against and contacting track member 99a and another end thereof biased again and contacting track member 99b as shown in FIG. 7(b). It is noted that brackets 91 at the top and bottom of the panel 5 extend away from the panel upwardly and downwardly, respectively, so that they do not hit or contact panel 3 during opening/closing of panel 5.

When it is desired to close the window panel 5, the panel 5 is moved sideways in direction 104 back toward the opening between fixed panels 1, 3. When panel 5 reaches and substantially fills the opening, the biasing force of spring 101 causes pivot member 95 to pivot clockwise about axis 97 as shown in FIG. 7 so that an end of member 95 moves into recess 99c defined by track member 99a. Pivoting of member 95 into the FIG. 7(a) position, as caused by spring 101, causes the panel 5 to move into the closed position shown in FIG. 7(a). Thus, it can be seen that spring 101 biases the window panel 5 into the closed (flush) position once end 106 of pivot member 95 moves in direction 104 past the beginning point 108 of recess 99c. In certain embodiments, a latch (not shown) may be provided in order to secure panel 5 in the closed/flush position shown in FIG. 7(a).

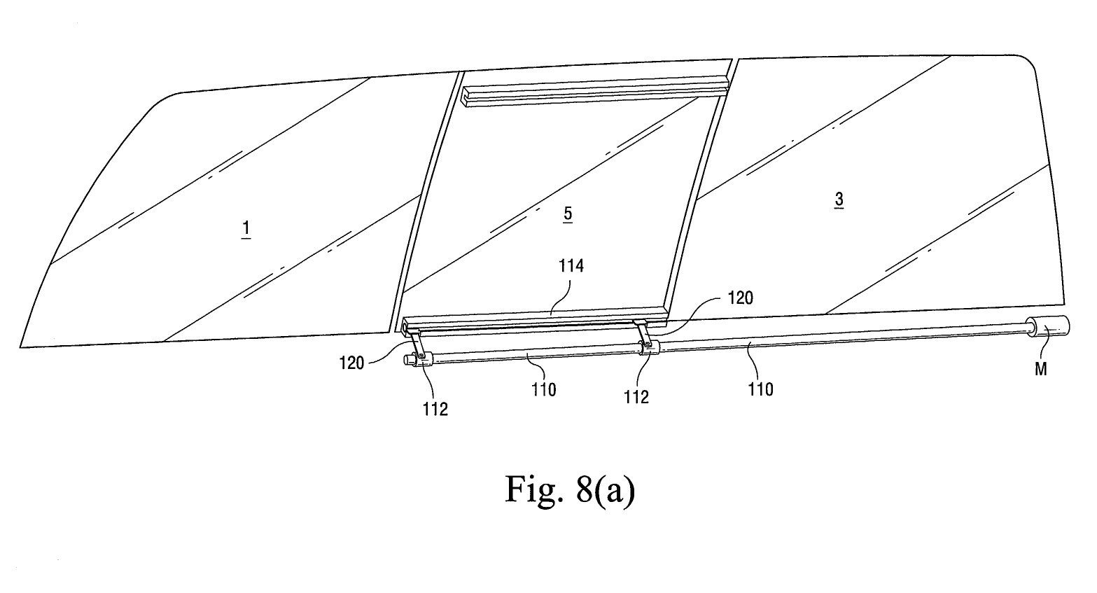

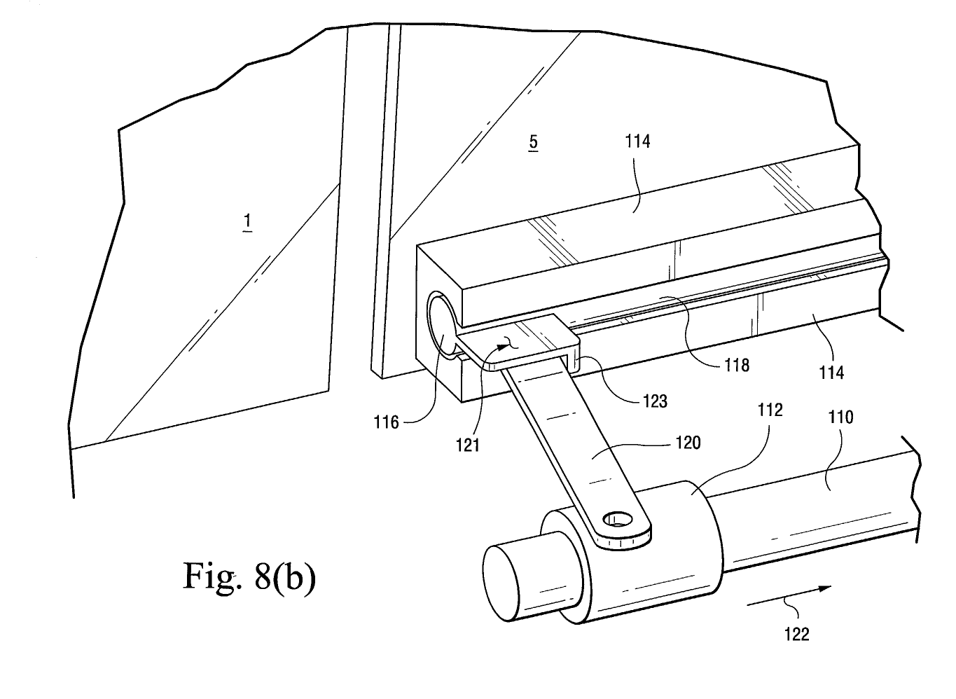

During opening/closing of panel 5, the panel may be moved sideways in direction(s) 103 and/or 104 either manually or via a power system. In manual embodiments, a user may use a handle or other portion associated with panel 5 to slide it open/shut. An example power sliding embodiment is discussed below with respect to FIG. 8.

FIGS. 8(a) and 8(b) illustrate a power system according to an example embodiment of this invention that may be used to cause panel 5 to move sideways for opening/closing. The power system for moving panel 5 of the FIG. 8 embodiment may be used in conjunction with one or more of the FIG. 1-7 embodiments, or separately therefrom in certain instances. The opening system of FIG. 8 is preferably located on the exterior side of window panels 1, 3, 5 in certain embodiments of this invention.

The FIG. 8 power opening system includes elongated screw 110, a pair of collars 112 having threaded interiors for receiving screw 110, bracket 114 mounted on the exterior surface/side of central window panel 5, associated with each collar 112 a sliding member 116 that slides in an elongated channel 118 defined in bracket 114, and pivotal links 120 which interconnect and extend between collars 112 and sliding members 116, optionally via brackets 121. Links 120 may be pivotally connected to both brackets 121 and collars 112 in certain embodiments of this invention, to enable flexibility upon popping out and popping in of panel 5 as described above with respect to other embodiments of this invention. This illustrated assembly may be provided at only the top or bottom of the window panels, or alternatively separate such power opening assemblies may be provided at the top and bottom of the panels 1, 3, 5.

Operation of the power system of FIG. 8 will now be described. In order to slide window panel 5 sideways in order to open the same, motor M turns elongated screw 110. When screw 110 turns, this causes threaded collars 112 to move thereon in direction 122. Lateral/sideways movement of collars 112 in direction 122 in turn causes links 120 to move in that direction until contacting stop portions 123 of brackets 121, which of course causes brackets 121 and thus sliding members 116 to slide sideways in direction 122 down slot/channel 118 as panel 5 moves in direction 122 to the open position. The window may be closed in a similar manner by simply reversing the direction that screw 110 is turned.

Once given the above disclosures, many other features, modifications, and/or improvements will become apparent to the skilled artisan. Such other features, modifications, and/or improvements are therefore considered to be a part of this invention, the scope of which is to be determined by the following claims.

What is claimed is:

1. A rear window assembly for a pick-up truck, comprising:
first and second fixed window panels;
a slidable window panel located between and approximately flush with the first and second fixed window panels when in a closed position;
at least upper and lower elongated tracks for enabling the slidable window panel to slide from the closed position to an open position, and wherein each of said upper and low tracks are on an inboard side of said slidable window panel.

2. The window assembly of claim 1, further comprising a lower support arm having at least one roller operatively associated therewith, said lower support arm extending from a lower portion of said slidable window panel; and
an upper support arm having at least one roller operatively associated therewith, said upper support arm extending from an upper portion of said slidable window panel.

3. The window assembly of claim 2, further comprising at least one opaque layer provided on an exterior surface of said slidable window panel near an edge thereof in order to shield from view at least one of said support arms.

4. The window assembly of claim 2, further comprising a spoiler mounted proximate a roof of said pick-up truck, said spoiler being located so as to shield from view at least of portion of said upper track.

5. The window assembly of claim 1, wherein the lower track is at an elevation below an upper end of a front bed wall of the pick-up truck.

6. The window assembly of claim 1, wherein said upper and lower tracks are approximately parallel to one another, and both function to support a leading edge of the slidable panel when the panel is being slid open.

7. The window assembly of claim 1, wherein the slidable panel is located between a bed of the pick-up truck and said tracks.

8. A rear window assembly for a pick-up truck, comprising:
first and second fixed window panels;
a slidable window panel located between and approximately flush with the first and second fixed window panels when in a closed position;
at least upper and lower elongated tracks for enabling the slidable window panel to slide from the closed position to an open position, and vice versa;
a pivot member attached to the slidable window panel via at least one support, the pivot member sliding in one of the elongated tracks during opening and closing of the slidable window; and
a spring applying a biasing force to the pivot member so that the slidable window is biased toward a position where it is approximately flush with the first and second fixed window panels.

9. The rear window assembly of claim 8, wherein the track in which the pivot member slides includes first and second track members (99a, 99b) where certain portions of the first and second track members of the track are approximately parallel with one another, and wherein a cavity (99c) is defined in the first track member (99a) so that when the pivot member is adjacent the cavity the pivot member is biased by the spring so that at least an end of the pivot member moves into the cavity.

10. The rear window assembly of claim 8, wherein said support comprises an approximately L-shaped bracket that is adhered to the slidable window panel via an adhesive.

11. A rear window assembly for a pick-up truck, comprising:
first and second fixed window panels;
a slidable window panel located between and approximately flush with the first and second fixed window panels when in a closed position; and
means for biasing the slidable window panel toward the closed position where it is approximately flush with the first and second fixed window panels, the means for biasing comprising a spring for biasing a pivoting member that is operatively associated with the slidable window panel.

12. The rear window assembly of claim 11, further comprising at least upper and lower elongated tracks for enabling the slidable window panel to slide from the closed position to an open position, and vice versa, and wherein the pivot member slides in one of the tracks during opening and closing of the slidable window.

13. The rear window assembly of claim 12, wherein the tracks are on the inboard side of the window panels, and wherein the slidable window panel slides on the outboard side of the fixed panels during the opening and closing of the slidable window.

14. The rear window assembly of claim 12, where the pivot member is attached to the slidable window panel via at least one support bracket, and wherein the pivot member is pivotally connected to the support bracket via a pivot axis (97).

15. The rear window assembly of claim 11, further comprising a power system for moving the slidable window panel laterally during opening and closing of the slidable window panel, the power system comprising an elongated screw (110) on which at least one threaded collar (112) is threadedly mounted, said at least one collar being operatively associated with the slidable window panel so that during opening of the slidable window panel rotation of the screw causes the collar and the slidable window panel to move laterally.

16. The rear window assembly of claim 8, wherein the tracks are on the inboard side of the window panels, and wherein the slidable window panel slides on the outboard side of the fixed panels during the opening and closing of the slidable window.

17. The rear window assembly of claim 8, further comprising a power system for moving the slidable window panel laterally during opening and closing of the slidable window panel, the power system comprising an elongated screw (110) on which at least one threaded collar (112) is threadedly mounted, said at least one collar being operatively associated with the slidable window panel so that during opening of the slidable window panel rotation of the screw causes the collar and the slidable window panel to move laterally.

18. A rear window assembly for a pick-up truck, comprising:
first and second fixed window panels;
a slidable window panel located between and approximately flush with the first and second fixed window panels when in a closed position; and
a power system for laterally moving the slidable window panel during opening and closing of the slidable window, the power system comprising an elongated screw on which at least one threaded collar is threadedly mounted, said at least one collar being attached to the slidable window panel via at least a pivoting link member pivotally associated with the collar and a bracket having a channel defined therein for slidingly receiving a sliding member attached to the link so that during opening of the slidable window panel rotation of the screw causes the collar, the link, the sliding member and the slidable window panel to move laterally.

19. The rear window assembly of claim 18, wherein the collar and the sliding member are pivotally connected to opposite ends of the link.
